(19) United States
(12) Patent Application Publication
(10) Pub. No.: US 2002/0173942 A1
(43) Pub. Date: Nov. 21, 2002

(54) Method and apparatus for design validation of complex IC without using logic simulation

(76) Inventors: Rochit Rajsuman, Santa Clara, CA (US); Hiroaki Yamoto, Santa Clara, CA (US)

Correspondence Address: MURAMATSU & ASSOCIATES, Suite 225, 7700 Irvine Center Drive, Irvine, CA, 92618, US

(21) Appl. No.: 10/093,280

(22) Filed: Mar. 7, 2002

Related U.S. Application Data
(60) Provisional application No. 60/275,883, filed on Mar. 14, 2001.

(51) Int. Cl. G06F 17/50

(52) U.S. Cl. 703/14

(57) ABSTRACT

A method and apparatus for design validation of complex IC with use of a combination of an event tester and a field programmable gate array (FPGA) or an emulator board. The design validation method eliminates logic simulation which is a bottleneck in design validation today. Because of the elimination of slow simulation from the design validation flow, extensive design validation can be done before design is taped-out for manufacturing, and because extensive design validation become possible, it eliminates the need of a prototype before mass production.

This application claims the benefit of U.S. Provisional Application No. 60/275,883 filed Mar. 14, 2001.

### FIELD OF THE INVENTION

This invention relates to a method and apparatus for design validation of complex IC, and more particularly, to a method and apparatus for evaluating and validating the design of a complex IC such as a system-on-a-chip by using an event based test system at high speed and low cost without using logic simulation.

### BACKGROUND OF THE INVENTION

At the present time, VLSI design is described in blocks and sub-blocks using a high-level description language such as Verilog and VHDL. These Verilog/VHDL designs are then simulated at behavioral and gate-level using Verilog/VHDL logic simulators. Such a design environment is called an electronic design automation (EDA) environment. The simulation in the EDA environment is targeted to check the functionality and performance before the design is fabricated into silicon IC. At the present time, simulation speed is too slow to do a full-chip simulation, hence, today designs are validated only partially.

Design validation is one of the most important and difficult tasks in complex IC design because without full functional verification, design errors are not found and removed. At the same time, full-chip level design validation is an absolute necessity in the product development cycle. Because of the slow simulation speed and large size of present day designs, chip level design validation is almost an impossible task with the present day tools and methodologies (M. Keating and P. Bricaud, “Reuse methodology manual for system-on-a-chip design”, Kluwer Academic publishers, 0-7923-8175-0, 1998; R. Rajsuman, “System-on-a-Chip: Design and Test”, Artech House Publishers Inc., ISBN 1-58053-107-5, 2000).

Design validation is one of the most important tasks in any system design project such as a design of SoC noted above (R. Rajsuman, “System-on-a-Chip: Design and Test”, 2000). Design validation means to establish that the system does what it intended to do. It essentially provides a confidence in the system operation. The objective of design validation is to prove that the product indeed works as intended (find out if it works as intended). Design validation of complex ICs can be considered as validation of hardware operation, which includes both functionality and timing performance. In the present day technology, design validation is obtained by extensive behavioral, logic and timing simulation; and/or by emulation; and/or by hardware prototype.

In the early phase of an IC design, along with the specification development and RTL (Register Transfer Level) coding, behavioral models are developed so that the testbenches can be created for system simulation. In the early phase, the objective is generally to develop a good set of block level test suites and test cases, it is done by the time register transfer level (RTL) design and functional models are specified. Efficient validation depends on the quality of test and completeness of testbenches, the abstraction level of various models, EDA tools and the simulation environment.

The design validation strategy follows design hierarchy. First, the leaf level blocks are checked for correctness in a stand-alone way. After functionality checking of these blocks, the interfaces between the blocks are checked for correctness in terms of transaction types and data contents.

The next and the most important step is to run application software or equivalent testbenches on full-chip model. As application of software can only be verified by runtime executions of the software on the chip, a hardware-software co-simulation is required. Co-simulation can be done at an instruction set architecture (ISA) level, a bus functional model (BFM) level or using a behavioral C/C++ model. Besides co-simulation, the other techniques in use to day for validation are emulation and/or hardware prototypes (C. Flynn “Developing an emulation environment”, Integrated System Design Magazine, pp. 46-52, April 2001; A. Dieckman “HW-SW co-verification with emulation, cosimulation and FPGA based prototyping”, Proceedings of Design and Test in Europe, pp.98-101, 2001; R. Ulrich et al. “Debugging of FPGA based prototypes-A case study”, Proceedings of Design and Test in Europe, pp.109-113, 2001).

The cost of Emulation systems is quite high (on the order of 1-million dollars); however, their speed is much faster than the speed of co-simulation (Emulation provides roughly l00K to 1M clock cycles/sec). An approximate comparison of simulation speed at different level of design description is shown in FIG. 1. Here, as noted above, BFM stands for a bus functional model level, ISA stands for an instruction set architecture level, and RTL stands for a register transfer level. Further, “Logic” in FIG. 1 means a gate level such as used in a netlist. Any of the existing tools and methodology does not allow extensive runs of the software applications for design validation; hence, only a limited amount of chip functionality is validated.

Despite the best attempt by engineers to make the first silicon fully functional, only about 80% designs work correctly when tested at the wafer level, but more than half fail when put into the system for the first time. The primary reason is the lack of system level validation with sufficient amount of real software application run. The FPGA based prototyping is still not adequate as design validation is very cumbersome and still slow because it uses EDA simulation tools (A. Dieckman “HW-SW co-verification with emulation, co-simulation and FPGA based prototyping”, Proceedings of Design and Test in Europe, pp.98-101, 2001; R. Ulrich et al. “Debugging of FPGA based prototypes-A case study”, Proceedings of Design and Test in Europe, pp.109113, 2001).

Thus, the only means to do the design validation in the present day technology is by silicon prototyping such as making the ASIC itself. The present day product development cycle is illustrated in FIG. 2. As shown in FIG. 2, prototype silicon is fabricated. This prototype silicon is used to develop a system board on which full functional validation is done (in-system test). All errors in the operation of prototype chip are debugged; design is corrected and finally mass production is done.

More specifically, in FIG. 2, designers study the requirements of a complex IC to be designed at stage 21. Based on the requirements in the stage 21, the designers determine the specifications of the IC at stage 22. In the design entry process in stage 23, the IC is described in blocks and sub-blocks using a high level language such as Verilog/VHDL. In stage 24, an initial design evaluation is made through a design verification process 25 typically logic/timing simulation 26 with use of initial testbenches 28. As a result of executing the logic simulation, an input/output data file or a VCD (Value Change Dump) file 29 will be created. The data in the VCD file 29 is a list of input and output events with respect to time lengths or delays, i.e., data in an event format.

Based on the design data created in the foregoing, a silicon prototype is built in a process designated by numeral 30. In this process, at stage 31, fabrication is done to obtain a silicon prototype 33. The resultant silicon prototype 33 is examined in stages 32 and 35 for any error. Today, such test is carried out with use of an IC tester which is a cycle based test system having an architecture for generating test vectors based on test pattern data in a cycle format.

The cycle based test systems (ATE systems) are not able to directly utilize the VCD file 29 produced under the EDA environment, since the VCD file is in the event format. Thus, the test vector in the VCD file is converted to cycle format data in a cyclization step 34. Further in step 34, the test program has to be developed based on the cycle format data because, many times, the test vectors in the event format cannot be completely converted to the cycle format test vectors. Still, such verification by IC testers today involves incomplete and inaccurate results. It is also time consuming to convert the event format data from the EDA environment to the cycle format test pattern data for the cycle based test system.

The silicon prototype 33 is further validated in a design validation and debug process 40 where an in-system test 37 is performed on the silicon prototype 33. In the in-system test 37, the silicon prototype 33 is mounted on a circuit board as a part of an intended system. During the in-system validation, errors and causes of the errors are detected and the design bugs are be fixed in stage 39. Since such an in-system test requires both a silicon prototype of the designed chip and a system with application software to run the silicon prototype, it is not only costly but also time consuming.

During the silicon prototype phase 30 and the validation phase 40 in FIG. 2, design errors are found and causes of such errors are determined and design errors are corrected through repeated interactions between design engineers and test engineers. The final design 41 is reached and the logic/timing simulation 43 for the final design 41 is conducted with use of a new testbench 45. Then the design is fabricated to silicon 49 and a production test 47 is performed on the silicon 49.

It should also be noted that there is no closed loop in the conventional flow as shown in FIG. 2, i.e., all steps are sequential, from the initial design to the prototype silicon to debug/validation to final design. Because of this sequential nature, these steps are extremely time consuming and costly; also, any error in any step requires a complete re-work.

To overcome these deficiencies, an event tester based method has been proposed by the same assignee of this invention in U.S. patent application Ser. Nos. 09/428,746 and 09/941,396. In the method disclosed in the U.S. patent applications, a prototype silicon and an initial simulation testbench are used together with EDA tools for design validation using event based test system (event tester) For this purpose, the EDA tools and simulator were linked to the event tester to execute the original design simulation vectors and testbench and to make modifications in the testbench and test vectors until satisfactory results are obtained. Because the EDA tools are linked with the event tester, the modifications were captured to generate a final testbench that provides satisfactory results.

An example in this method is illustrated in FIG. 3. It should be noted that this example is a conventional technology only to the assignee of this invention but not in the public domain nor prior art to the present invention. The fundamental difference in FIG. 2 and FIG. 3 is that the flow in FIG. 3 provides a closed loop from initial design to prototype to debug/validation to bug fixes to final fabrication or mass production.

According to the above noted patent applications and FIG. 3, for full functional verification or chip level design validation, the full chip level functional vectors developed during design simulation (initial testbench) are executed on the event tester. These test vectors are also in the event format, typically generated by the software application running on the Verilog/VHDL model or behavioral model of the IC. These vectors exercise different parts of the IC simultaneously or at different time, however, the overall behavior of the IC is determined by the combined response. After this step, a silicon chip is fabricated as shown in FIG. 3.

Once this chip becomes available, it is put on the event based system and design simulation vectors of initial testbench are executed to verify the chip's operation. More specifically, in FIG. 3, an event tester 52 tests the function of the silicon prototype 33 using the test vectors produced based on the event data derived from the VCD (value change dump) file 29. Since the VCD file 29 is in the event format, the data in the VCD file 29 can be directly used in the event tester 82 to test the design.

The EDA tools such as simulation analysis/debug 55 and waveform editor/viewer 56 are linked to the event tester 52 through an interface 67 such as API (Programmed Application Interface). The event tester 52 incorporates software tools for editing and viewing waveforms such as event waveform editor/viewer 58 and DUT (device under test) waveform editor/viewer 59. The editor/viewer 58 and 59 are linked to the EDA tools 55 and 56 through the API interface 67 for communicating and accessing common data base with one another. In the event tester 52, the test vectors (events) can be modified through the event waveform editor/viewer 58.

By executing the test vectors, the event tester 52 produces a test result file 53 which is feedbacked to the EDA design environment and to the EDA tools through a testbench feedback 69. The results are examined on the event tester 52 and events are changed/edited on the event tester 52 (editor/viewer 58 and 59) until all incorrect operations of the device (intended design) are rectified. These changes in the events create a new testbench 51. To obtain such a new testbench and test vectors, EDA tools consisting of testbench generation tools 65, simulation analysis tools 55 and waveform viewer 56 are linked to the event tester 52. After these processes, in FIG. 3, final silicon fabrication (mass production) is done at stage 61 to produce the final IC devices 62 which will be tested in a production test stage 63.

The method of FIG. 3 still requires physical silicon (prototype) for design validation. Because of the need of physical silicon, process is still costly. To overcome this limitation, the above U.S. patent application Ser. No. 09/941,396 discloses an alternative process that uses the initial design description and its simulation testbench to generate a new testbench and a corresponding device model that is bug free. In this process, the initial design of the device is loaded on the event tester along with the initial testbench. Using the API interface, the event tester is also linked with the simulator that was used during the initial design. Thus, the event tester contains the design described in Verilog/VHDL and its all logic, behavioral, BFM, ISA and application testbenches.

Using the device model (initial design) and its testbenches, the results are examined on the event tester. Because the whole environment and results are in the event format, any incorrect operation in the device operation is quickly noticed. As event tester allows to edit events and time scaling, the events corresponding to these incorrect operations are edited to correct the operation. When all incorrect operations are corrected, the device model is saved and a new testbench and test vectors are generated. This saved device model is used for silicon fabrication and mass production.

The one limitation remains that this method is still based upon simulation; hence, it is still slow. What is needed is a new method and apparatus for design validation to overcome this limitation.

### SUMMARY OF THE INVENTION

It is, therefore, an object of the present invention to provide a method and apparatus for design validation of complex IC by using an event based test system at high speed and low cost without using logic simulation.

In the first aspect of the present invention, the method of validating design of complex IC includes the steps of: connecting a field programmable gate arrays (FPGA) to an event tester, inline programming the FPGA through the event tester based on design data produced under the EDA environment to build an IC equivalent to an intended IC in the FPGA, applying test vectors derived from the IC design data to the FPGA by the event tester and evaluating a response output of the FPGA, detecting errors in the response output and correcting design errors by modifying the inline programming of the FPGA, and repeating the error detection and design correction step until error free design data is obtained in the event tester.

Preferably, the method of the present invention further includes a step of receiving the design data and converting the design data for the inline programming the FPGA. The step of inline programming the FPGA through the event tester includes a step of transmitting programming data to the FPGA through a control bus of the event tester.

In the present invention, preferably, the step of applying the test vectors includes a step of running a testbench created under the EDA environment and application software prepared for the intended IC on the FPGA through the event tester.

The method of the present invention further includes a step of extracting event data through a testbench created under the EDA environment, and a step of installing the extracted event data in the event tester and generating the test vectors based on the extracted event data to apply the test vectors to the FPGA through a test fixture of the event tester.

In the second aspect of the present invention, the method of validating design of complex IC utilizes an emulator board rather than FPGA. The method include the steps of: connecting an emulator board to an event tester, supplying design data of an intended IC to the emulator board so that the emulator board emulates functions of the intended IC, applying test vectors derived from the IC design data to the emulator board by the event tester and evaluating a response output of the emulator board, detecting errors in the response output and correcting design errors by modifying the design data supplied to the emulator board, and repeating the error detection and design correction step until error free design data is obtained in the event tester.

A further aspect of the present invention is an apparatus for validating design of complex IC. The design validation apparatus is configured by various means for achieving the design validation methods described above which utilizes a combination of the event tester and the FPGA or a combination of the event tester and the emulator board for high speed test pattern application and response evaluation as well as design debugging and error correction.

According to the present invention, in instead of using the slow EDA simulation tools, it uses the event tester and in-line programming of FPGAs to validate the design. Because full chip level simulation is not used and application software runs much faster on FPGA (in comparison to simulation), extensive validation can be done that is not possible in today's technology.

Because of the elimination of slow simulation from the design validation flow, extensive design validation can be done before design is taped-out for manufacturing, and because extensive design validation become possible, it eliminates the need of a prototype before mass production. The validation method in the present invention is very efficient, less costly and fundamentally different from any previously described system.

### BRIEF DESCRIPTION OF THE DRAWINGS

FIG. 1 is a diagram showing a relationship between the simulation speeds and various abstraction levels involved in the design process for complex IC.

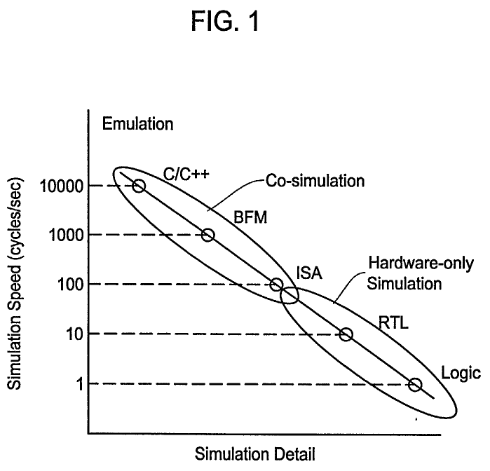

FIG. 2 is a schematic diagram showing an example of process in the design validation in the conventional technology.

FIG. 3 is a schematic diagram showing an example of method of design validation which is an internal knowledge by the assignee and subject to U.S. patent application Ser. No. 09/941,396.

FIG. 4 is a block diagram showing a basic configuration of the apparatus and method for design validation of the present invention using inline-programmed FPGAs in combination with an event tester.

FIG. 5 is a schematic diagram showing an example of FPGA configuration in the present invention which incorporates a parallel and daisy-chain arrangement.

FIG. 6 is a block diagram showing a basic configuration of the apparatus and method for design validation of the present invention using an emulator board in combination with an event tester.

FIGS. 7A and 7B are schematic diagrams for comparing the method of FIG. 3 with the present invention.

### DETAILED DESCRIPTION OF THE INVENTION

In the previous applications owned by the same assignee of this invention, an event based test system is described in U.S. patent application Ser. Nos. 09/406,300, 09/340,371 and 09/286,226. Here, all of these patent applications are incorporated by reference. In the present invention, a new method and apparatus changes the design paradigm by overcoming the limitations involved in the conventional technologies.

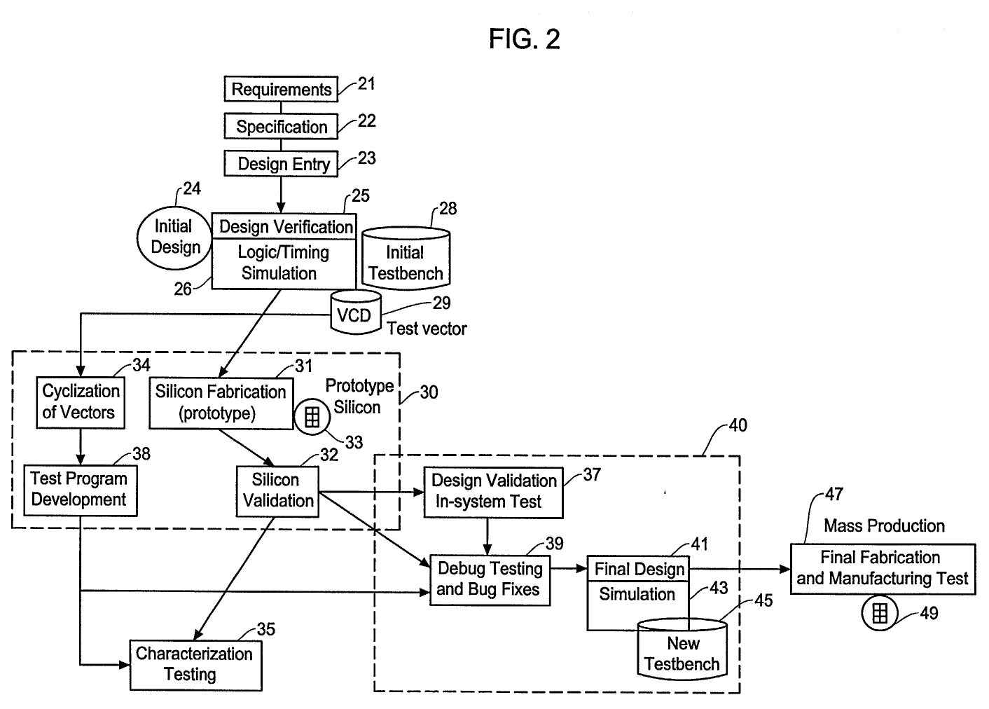

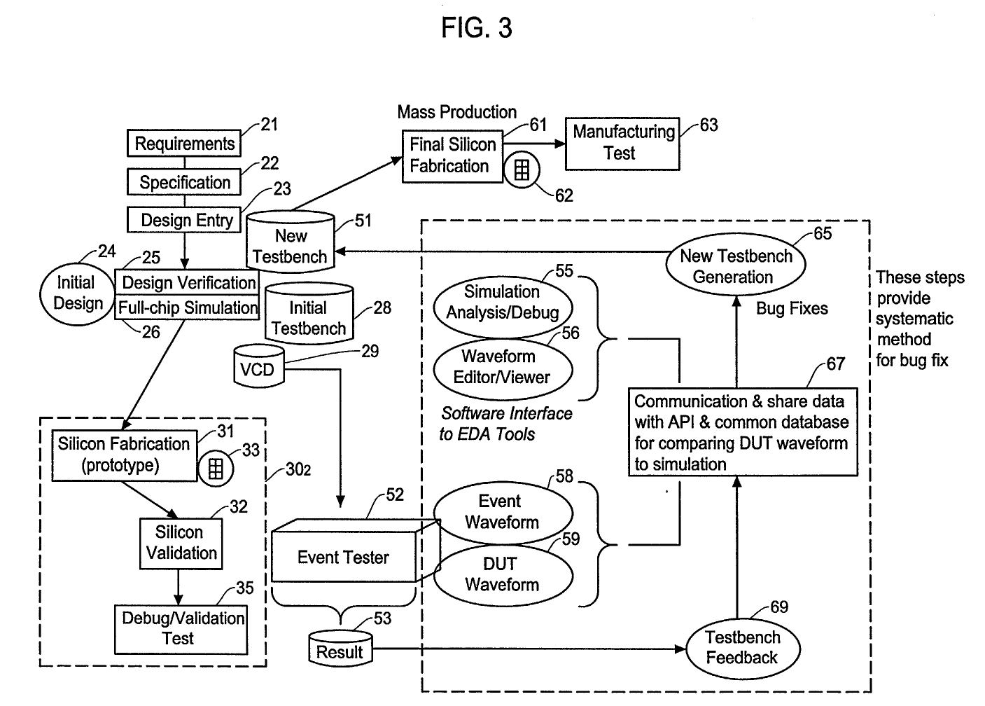

As is known in the art, IC testers have a test rate of higher than 100 MHz up to 1 GHz, for example, which is much faster than any existing logic simulators. As described in the foregoing, the conventional technologies shown in FIGS. 2 and 3 is not able to utilize the high speed test rate of an IC tester because the validation method includes the logic simulator. The present invention improves designer's productivity by accelerating the design procedure itself by eliminating slow simulation from the design validation flow.

This invention provides two major benefits: (1) because the elimination of slow simulation from the design validation flow, extensive design validation can be done before design is taped-out for manufacturing; (2) because extensive design validation become possible, it eliminates the need of a prototype before mass production. The validation method in the present invention is very efficient, less costly and fundamentally different from any previously described system.

Instead of using slow EDA simulation tools, the present invention uses an event based test system (event tester) and inline programming of FPGAs to validate the design. The basic event based system was described in U.S. patent application Ser. Nos. 09/406,300 and 09/340,371. Through a control bus in the event tester, FPGAs can be programmed on the event tester itself (inline programming). Thus, one or more FPGAs can be used on the event tester to implement the netlist (typically, gate level description) of a complex chip.

As these FPGAs implement the actual design, the software application can be run through the event tester to validate the design. Any error during software application run is detected by the event tester and diagnosed directly on the event tester. As FPGA can be programmed inline, the cause of error can be corrected in the design netlist. This allows running real software applications for extended periods and thus permits extensive validation.

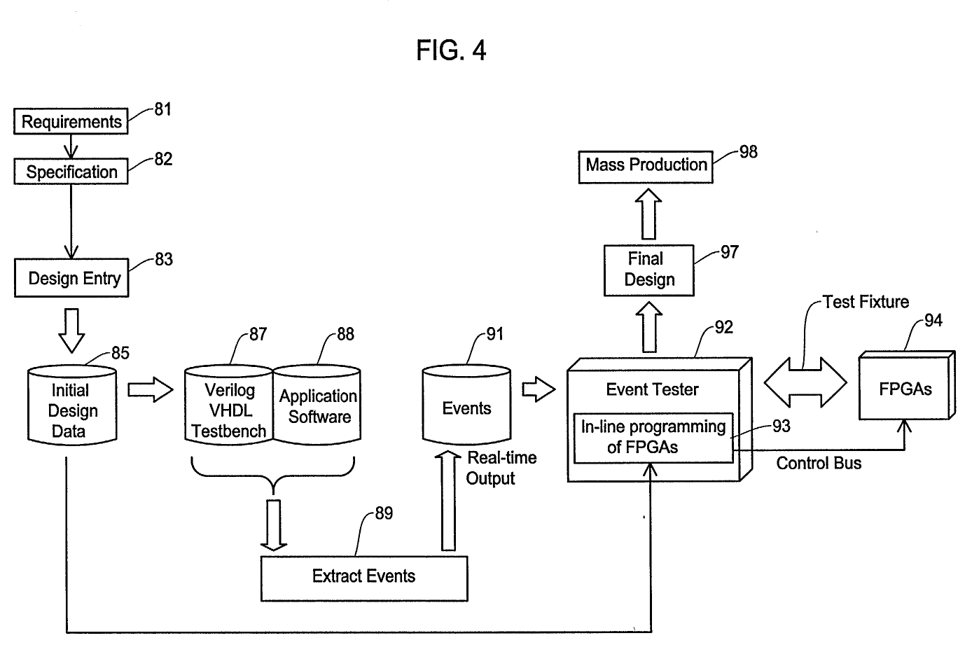

The method is illustrated in FIG. 4. In this example, an event tester 92 connects an FPGA (Field Programmable Gate Array) board 94 through a control bus. Similar to the example shown in FIGS. 2 and 3, under the EDA environment, initial design data 85 of a complex IC is created through design stages 81-83. A testbench 87 is also created which is typically a Verilog/VHDL testbench. An application software 88 for the IC may also be completed at this stage. An event data file 91 will be created through an event extracting process 89 based on the testbench data 87 and the application software 88.

As is known in the art, FPGAs have memories therein for configuring an intended circuit. Thus, by writing appropriate data in the memories (programming) in the FPGAs, even a large scale integrated circuit can be created in the FPGAs. In the present invention, the event tester 92 provides the configuration data to the FPGAs through the control bus for programming (inline programming) the FPGAs. Typically, such configuration data is created by translating the events 91 based on rules unique to the FPGAs which is installed in an inline programming 93.

After forming the intended IC in the FPGA board 94, the event tester applies test patterns (test vectors) through a test fixture (such as pogo-pins). Any error during the test application is detected by the event tester and diagnosed directly on the event tester. As FPGA can be programmed inline, the cause of error can be corrected in the design netlist. As disclosed in the above noted patent applications, the event tester is able to changes the events (test patterns) in timings, attributes and a repetition rate (event scaling), extensive test can be performed on the design. Further, the combination of the event tester and the FPGA allows high speed operations, at speed software applications for extended periods is possible, thus achieves extensive validation. After all the errors are detected and design is corrected, final design 97 is established which is used for a mass production stage 98.

In the implementation of this invention, the FPGA board 94 is mounted on the test fixture and several signals connected to the test fixture are used for controlling the FPGAs. These signals provide a variety of functions; the FPGA inline programming is also obtained through these signals. Examples of such signals include:

(1) A 32-bits control bus and a 32-bits control word. These signals are currently implemented as open collector on tester controller. These signals can also be implemented as bi-directional signals.

(2) 64-bits analog I/O signals. Both the 32-bits control word and 64-bits signals have generic interface and each individual bit can be separately controlled.

(3) Power connections: In the present implementation, there are 16 DUT (device under test) power connections, +5V, +15V, −5V, −15V; each DUT power supply is 8V at 2A. These power supplies have parallel connections as well as floating terminals for higher voltage range applications.

The in-line programming of FPGAs can be done using either parallel interface or serial interface. With serial interface, many devices can be connected in daisy chain fashion. With this method, only two control signals are used to program all of the FPGAs in the system. Another possibility is to use the bus and configure multiple FPGAs in parallel. For parallel configuration, each device requires its own clock and data. With both buses, a total of 96 control bits are available; hence, up to 48 FPGAs can be programmed in parallel (one clock and one data line to each FPGA).

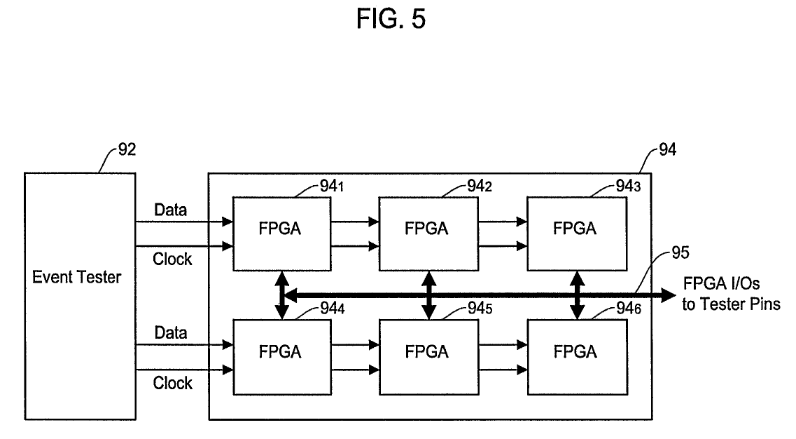

A third possibility is a combination of parallel and daisy chain connection; this is the most generic method and illustrated in FIG. 5. In the example of FIG. 5, the FPGA board 94 include series and parallel connected FPGAs 94₁-94₆. The event tester 92 provides the data and clock in a parallel fashion to the FPGAs 94 for inline programming (building the intended IC in the FPGAs). The resultant IC includes an interface 95 which will be used for communication with pin cards of the event tester through the test fixture for test execution.

As in the foregoing, instead of using the slow EDA simulation tools, the present invention uses the event tester and inline programming of FPGAs to validate the design. Because full chip level simulation is not used and application software runs much faster on FPGA (in comparison to simulation), extensive validation can be done that is not possible in today's technology.

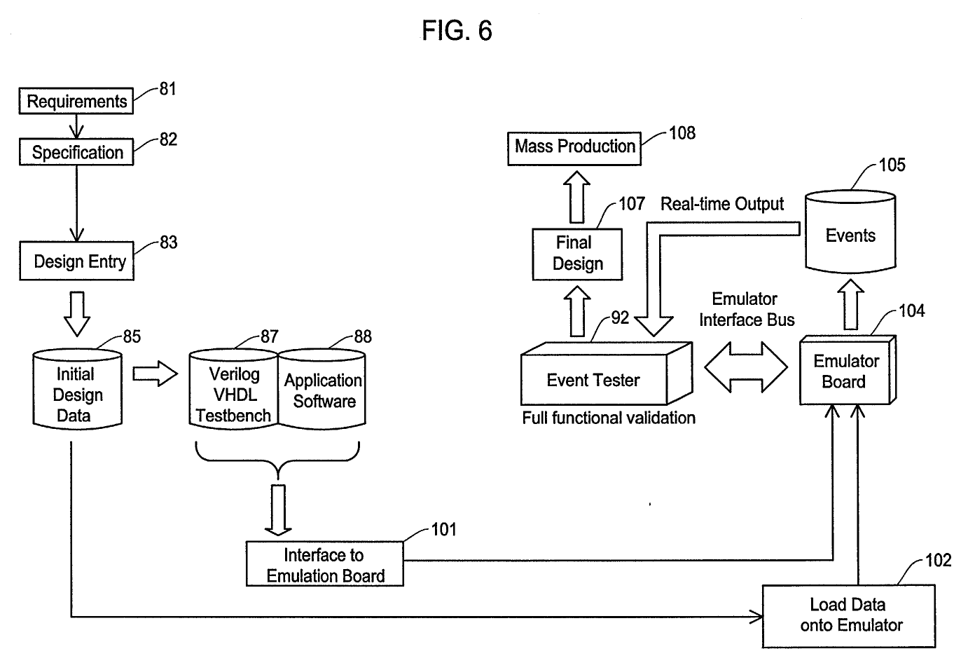

FIG. 6 shows another embodiment of the present invention which uses an emulator board instead of the inline programming of FPGAs. In this case, the event tester control bus (32-bits control word and 64 bits analog signals noted above) is mapped to the emulator interface bus (emulator interface is generally either 32-bits or 64-bits; thus, only 32-bits or 64-bits are used out of possible 96 bits available through the control bus). The emulator vendor such as Ikos Systems have made emulation interface public so that emulation systems can be connected to any other system.

Because of publicly available interface to emulation system; inline programming of FPGAs can be avoided by using an emulator board as shown in FIG. 6. Because it uses only an emulator board (not an entire emulation system), the cost is much lower than the emulation system, although the cost is slightly higher than the FPGA implementation. Also, as the design is loaded and application software is run on the emulation board while design errors are debugged on the event tester, validation speed is limited to the speed of communication bus that is slow.

More specifically, in FIG. 6, an emulator board 104 is connected to the event tester 92 through an emulator interface bus. The emulator board 104 receives data such as testbench and application software through an emulator board interface 101. The emulator board 104 is also loaded with design data through a loading step 102. Thus, the emulator board 104 emulates the design IC.

By running the testbench on the emulator board, event data is created in an event file 105. The event tester 92 uses this event data in the event file 105 to test the design on the emulator board 104 through the emulator interface bus and evaluate the response outputs of the emulator board 104. After all the errors are detected and design is corrected, final design 107 is established which is used for a mass production stage 108.

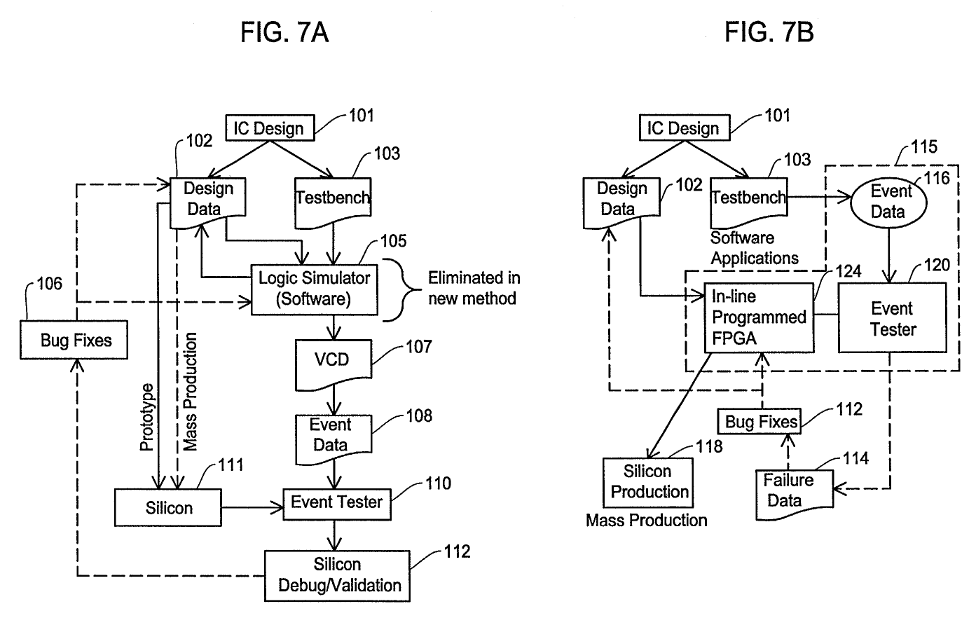

FIGS. 7A and 7B illustrate the side-by-side comparison of the present invention and the method of FIG. 3 (not prior art). Both in FIGS. 7A and 7B, through an IC design phase 101, a design data file 102 and a testbench 103 are created. Then, in the method of FIG. 7A, the process performs logic simulation 105 with use of the design data file 102 and the testbench 103. As is known in the art, the logic simulation which is configured by software process is very slow compared to the operation speed of the intended IC. In the method of FIG. 7A, based on the design data, a prototype silicon 111 is built which is tested by an event tester 110.

The logic simulator 105 produces input/output signal data, i.e, a VCD (Voltage Change Dump) file 107 from which an event data file 108 is created by extracting the event data. The event tester 110 produces test vectors and applies the test vectors to the silicon prototype 111. Thus, in a silicon debug and validation phase 112, the design error is detected and design bugs are fixed in phase 106 which is feedbacked to the design stage.

In the present invention shown in FIG. 7B, a test system 115 includes a combination of the event tester 120 and the FPGAs 124. The design data 102 is used to program the FPGAs to configure the intended IC therein. Event data 116 is produced with use of the testbench 103, and the event tester 120 generates the test vectors which are produced by the event data 116. Since the FPGAs 124 perform the functions of the intended IC at a speed closed to the actual IC, at-speed test with application software can be performed in the test method of the present invention.

As shown clearly in FIGS. 7A and 7B, the new method eliminates the logic simulator 105 from the design validation flow. Due to the slow speed, the logic simulation is a bottleneck in design validation today; elimination of simulation allows very extensive validation while still using less time. The new method allows to debug all design errors on the event tester 120 without requiring the prototype ASIC. The procedure is extremely cost effective and faster in comparison to existing methods.

As in the foregoing, in instead of using the slow EDA simulation tools, the present invention uses the event tester and inline programming of FPGAs to validate the design. Because full chip level simulation is not used and application software runs much faster on FPGA (in comparison to simulation), extensive validation can be done that is not possible in today's technology.

Because of the elimination of slow simulation from the design validation flow, extensive design validation can be done before design is taped-out for manufacturing, and because extensive design validation become possible, it eliminates the need of a prototype before mass production. The validation method in the present invention is very efficient, less costly and fundamentally different from any previously described system.

Although only a preferred embodiment is specifically illustrated and described herein, it will be appreciated that many modifications and variations of the present invention are possible in light of the above teachings and within the purview of the appended claims without departing the spirit and intended scope of the invention.

What is claimed is:

1. A method of validating design of complex integrated circuits (IC) where a design process is carried out under an electronic design automation (EDA) environment, comprising the following steps of:
connecting a field programmable gate arrays (FPGA) to an event tester;
inline programming the FPGA through the event tester based on design data produced under the EDA environment to build an IC equivalent to an intended IC in the FPGA;
applying test vectors derived from the IC design data to the FPGA by the event tester and evaluating a response output of the FPGA;
detecting errors in the response output and correcting design errors by modifying the inline programming of the FPGA; and
repeating the error detection and design correction step until error free design data is obtained in the event tester.

2. A method of validating design of complex IC as defined in claim 1, further comprising a step of receiving the design data and converting the design data for the inline programming the FPGA.

3. A method of validating design of complex IC as defined in claim 1, said step of inline programming the FPGA through the event tester includes a step of transmitting programming data to the FPGA through a control bus of the event tester.

4. A method of validating design of complex IC as defined in claim 1, said step of applying the test vectors includes a step of running a testbench created under the EDA environment and application software prepared for the intended IC on the FPGA through the event tester.

5. A method of validating design of complex IC as defined in claim 1, further comprising a step of extracting event data through a testbench created under the EDA environment.

6. A method of validating design of complex IC as defined in claim 5, further comprising a step of installing the extracted event data in the event tester and generating the test vectors based on the extracted event data to apply the test vectors to the FPGA through a test fixture of the event tester.

7. A method of validating design of complex integrated circuits (IC) where a design process is carried out under an electronic design automation (EDA) environment, comprising the following steps of:
connecting an emulator board to an event tester;
supplying design data of an intended IC to the emulator board so that the emulator board emulates functions of the intended IC;
applying test vectors derived from the IC design data to the emulator board by the event tester and evaluating a response output of the emulator board;
detecting errors in the response output and correcting design errors by modifying the design data supplied to the emulator board; and
repeating the error detection and design correction step until error free design data is obtained in the event tester.

8. A method of validating design of complex IC as defined in claim 7, further comprising a step of receiving the design data and converting the design data for the emulator board.

9. A method of validating design of complex IC as defined in claim 7, said step of applying the test vectors includes a step of running a testbench created under the EDA environment and application software prepared for the intended IC on the emulator board through the event tester.

10. A method of validating design of complex IC as defined in claim 7, further comprising a step of producing event data through a testbench created under the EDA environment.

11. A method of validating design of complex IC as defined in claim 10, further comprising a step of installing the event data in the event tester and generating the test vectors based on the event data to apply the test vectors to the emulator board through a test fixture of the event tester.

12. An apparatus for validating design of complex integrated circuits (IC) where a design process is carried out under an electronic design automation (EDA) environment, comprising:
means for connecting a field programmable gate arrays (FPGA) to an event tester;
means for inline programming the FPGA through the event tester based on design data produced under the EDA environment to build an IC equivalent to an intended IC in the FPGA;
means for applying test vectors derived from the IC design data to the FPGA by the event tester and evaluating a response output of the FPGA;
means for detecting errors in the response output and correcting design errors by modifying the inline programming of the FPGA; and
means for repeating the error detection and design correction until error free design data is obtained in the event tester.

13. An apparatus for validating design of complex IC as defined in claim 12, wherein said test vector apply means applies a testbench created under the EDA environment and application software prepared for the intended IC to the FPGA through the event tester.

14. An apparatus for validating design of complex integrated circuits (IC) where a design process is carried out under an electronic design automation (EDA) environment, comprising:
means for connecting an emulator board to an event tester;
means for supplying design data of an intended IC to the emulator board so that the emulator board emulates functions of the intended IC;
means for applying test vectors derived from the IC design data to the emulator board by the event tester and evaluating a response output of the emulator board;
means for detecting errors in the response output and correcting design errors by modifying the design data supplied to the emulator board; and
means for repeating the error detection and design correction until error free design data is obtained in the event tester.

15. An apparatus for validating design of complex IC as defined in claim 14, wherein said test vector apply means applies a testbench created under the EDA environment and application software prepared for the intended IC to the emulator board through the event tester.
